(19) United States
(12) Patent Application Publication
(10) Pub. No.: US 2026/0039594 A1
(43) Pub. Date: Feb. 5, 2026

(54) Method And Apparatus For Congestion Rejection Handling For High Priority User Equipment In Mobile Communications

(71) Applicant: MediaTek Inc., Hsinchu City (TW)

(72) Inventors: Yun-Fan Fu, Hsinchu City (TW); Yu-Hsin Lin, Hsinchu City (TW); Yung-Chun Yang, Hsinchu City (TW); You-Ru Chen, Hsinchu City (TW)

(21) Appl. No.: 19/276,511

(22) Filed: Jul. 22, 2025

Related U.S. Application Data
(60) Provisional application No. 63/677,487, filed on Jul. 31, 2024.

(51) Int. Cl. H04L 47/11; H04L 41/0816

(52) U.S. Cl. CPC H04L 47/11; H04L 41/0816

(57) ABSTRACT

Various solutions for congestion rejection handling for high priority user equipment (UE) in mobile communications are described. The UE may receive a non-access stratum (NAS) message with a cause value indicating a congestion. The UE may perform a mobility management in an event that it is configured as a high priority apparatus. The performing of the mobility management may include starting a reattempting timer based on a reattempting counter, increasing the reattempting counter, and determining whether to initiate a mobility management procedure based on the reattempting timer.

### CROSS REFERENCE TO RELATED PATENT APPLICATION(S)

The present disclosure is part of a non-provisional application claiming the priority benefit of U.S. Patent Application No. 63/677,487, filed 31 Jul. 2024, the content of which herein being incorporated by reference in its entirety.

### TECHNICAL FIELD

The present disclosure is generally related to mobile communications and, more particularly, to congestion rejection handling for high priority user equipment (UE) in mobile communications.

### BACKGROUND

Unless otherwise indicated herein, approaches described in this section are not prior art to the claims listed below and are not admitted as prior art by inclusion in this section.

In 3rd Generation Partnership Project (3GPP), both 5G mobility management (5GMM) cause value #22 and evolved packet system (EPS) mobility management (EMM) cause value #22 are used to indicate network congestion. Upon receiving a message with either of these cause values, the user equipment (UE) learns that its request was denied because the network is experiencing congestion. This mechanism is critical for network load control and stability. The UE is then expected to react by backing off (usually controlled by a T3346 timer) to avoid further overwhelming the network. However, it is currently unclear how high priority UEs can retrigger a corresponding procedure that was previously rejected by the network. Therefore, a proper scheme for congestion rejection handling, specifically for high priority UEs, is needed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to congestion rejection handling for high priority user equipment (UE) in mobile communications.

In one aspect, a method may involve an apparatus receiving a non-access stratum (NAS) message with a cause value indicating a congestion. The method may also involve the apparatus performing a mobility management in an event that the apparatus is configured as a high priority apparatus. The performing of the mobility management includes starting a reattempting timer based on a reattempting counter, increasing the reattempting counter, and determining whether to initiate a mobility management procedure based on the reattempting timer.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a NAS message with a cause value indicating a congestion. The processor, during operation, may further perform operations comprising performing a mobility management in an event that the apparatus is configured as a high priority apparatus. The performing of the mobility management includes starting a reattempting timer based on a reattempting counter, increasing the reattempting counter, and determining whether to initiate a mobility management procedure based on the reattempting timer.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to congestion rejection handling for high priority user equipment (UE) in mobile communications. According to the present disclosure, a number of possible solutions may be implemented separately or jointly. That is, although these possible solutions may be described below separately, two or more of these possible solutions may be implemented in one combination or another.

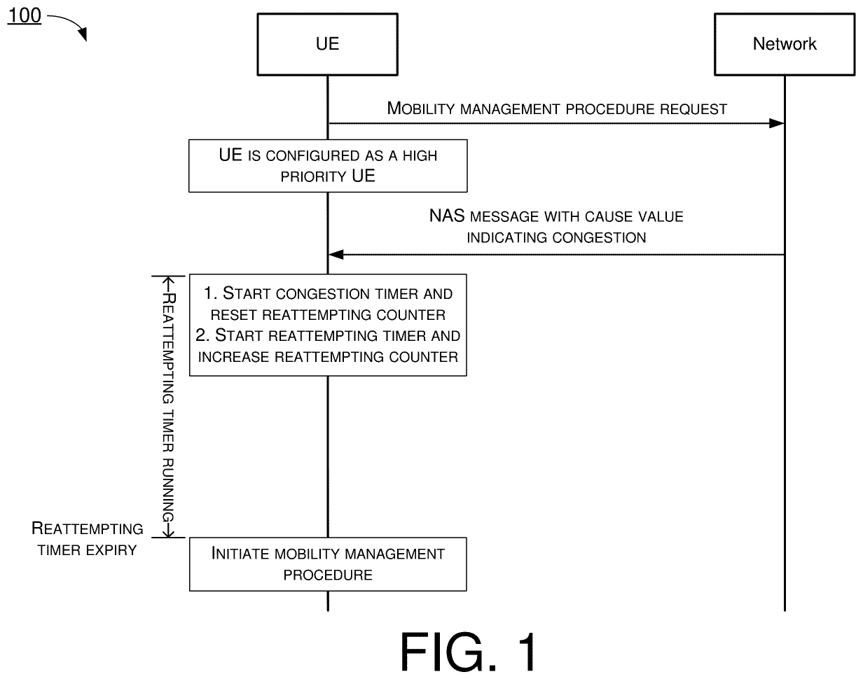

FIG. 1 illustrates an example scenario 100 under schemes in accordance with implementations of the present disclosure. In scenario 100, a UE may connect to a network, which may be an LTE network, a 5G/NR network, an IoT network, or a 6G network, the present disclosure is not limited thereto. The network may comprise one or more network nodes (e.g., base stations).

In scenario 100, the UE may transmit a request for mobility management procedure to the network, where the mobility management procedure may be an attach procedure, a tracking area update procedure, or a registration procedure. The UE is configured as a high priority UE (i.e., configured for high priority), based on the access control mechanism associated with the network, to receive preferential treatment from the network, especially during periods of network congestion or overload. In one embodiment, the UE is configured as a high priority UE if it is associated with a predefined access class (AC). In one example, the UE is configured as a high priority UE if it is configured to use AC 11-15 in a selected public land mobile network (PLMN). Alternatively, the UE is configured as a high priority UE if it is configured with at least one selected-PLMN- applicable AC in a predefined range (e.g., 11-15) on universal subscriber identity module (USIM). In another embodiment, the UE is configured as a high priority UE if it is associated with a predefined access identity. For example, the UE is configured as a high priority UE if it is configured with one or more access identities equal to 1, 2, or 11-15 applicable in the selected PLMN.

When network resources become congested and unable to process the request from the UE, the network may reject the request by sending a Non-Access Stratum (NAS) message with a cause value indicating congestion. The NAS message may be a mobility management message, an ATTACH REJECT message, a TRACKING AREA UPDATE REJECT message, or a REGISTRATION REJECT message. The cause value may be a 5G mobility management (5GMM) cause value #22, an evolved packet system (EPS) mobility management (EMM) cause value #22, or other cause values indicating network congestion.

Upon receiving such a NAS message, the UE configured for high priority may consider the congestion cause value an abnormal case and perform a corresponding mobility management. In one embodiment, the UE may start a congestion timer (e.g., a T3346 timer) after receiving the NAS message and reset a reattempting counter. Furthermore, the UE may start a reattempting timer (e.g., a T3402 timer, a T3411 timer, a T3502 timer, or a T3511 timer) based on the reattempting counter and increase the reattempting counter. Whether to initiate (or trigger) a mobility management procedure again is determined based on the reattempting timer. In one example, the UE may initiate the mobility management procedure upon the expiry of the reattempting timer. In another example, the mobility management procedure may be initiated when both the congestion timer and the reattempting timer have expired. That is, the mobility management procedure is not initiated while the congestion timer is running.

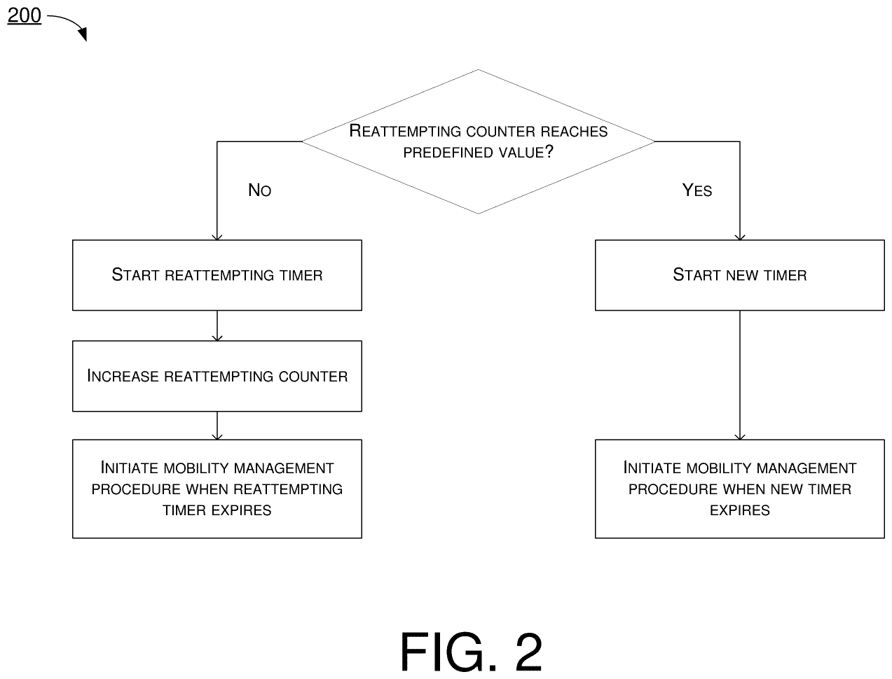

FIG. 2 illustrates an example scenario 200 under schemes in accordance with implementations of the present disclosure. In scenario 200, when performing the mobility management, the UE may determine whether the reattempting counter reaches a predefined value. If the reattempting counter is less than the predefined value, the UE may start a reattempting timer (e.g., a T3511 timer or a T3411 timer), increase the reattempting counter (e.g., increment by 1), and consider the congestion cause value an abnormal case. The mobility management procedure is to be initiated upon the reattempting timer's expiry. For example, if the predefined value is 5, the UE's reattempts will be limited to 5 times and governed by the reattempting timer's value. On the other hand, if the reattempting counter reaches the predefined value, the UE may start a new timer having a longer waiting period than that of the reattempting timer and initiate the mobility management procedure when the new timer expires. The new timer may be a T3502 timer or a T3402 timer, however, the present disclosure is not limited thereto.

In one embodiment, upon receiving a NAS message from the network, the UE determines several conditions: whether the UE is configured for high priority (i.e., a high priority UE); whether the NAS message contains a cause value indicating congestion, specifically 5GMM cause #22 or EMM cause #22; and whether the NAS message includes a T3346 value that is neither zero nor deactivated. If these conditions are met and no congestion timer is currently running (i.e., upon a high priority UE's initial reception of a congestion rejection), the UE proceeds to start a congestion timer (e.g., a T3346 timer), specifically noting that this congestion timer is initiated because the UE is configured for high priority. Concurrently, the UE starts a reattempting timer (e.g., a T3402 timer, a T3411 timer, a T3502 timer, or a T3511 timer), increments a reattempting counter, and considers the received cause value an abnormal case.

However, if a high priority UE already has congestion timer(s) running (e.g., due to previous congestion rejections), and it subsequently receives another congestion rejection, it may first stop any existing timers (i.e., currently running T3346 congestion timers). The UE may then initiate a new congestion timer (e.g., a T3346 timer), simultaneously start a reattempting timer (e.g., a T3402 timer, a T3411 timer, a T3502 timer, or a T3511 timer), increment a reattempting counter, and consider the received cause value an abnormal case. The mobility management procedure is not initiated while the new congestion timer is running.

In one embodiment, a first congestion timer is started during a first mobility management procedure if the UE is not configured for high priority. Conversely, a second mobility management procedure may be performed if the UE is configured for high priority and the first congestion timer is running. Specifically, upon receiving the NAS message from the network, the UE determines if it is configured for high priority. If the NAS message contains a congestion cause value (e.g., 5GMM cause #22 or EMM cause #22), the NAS message includes a T3346 value that is neither zero nor deactivated, and/or if a first congestion timer is currently running (with that timer having been started due to the UE receiving a second NAS message), the UE proceeds to stop the first congestion timer, start a second congestion timer, initiate a reattempting timer while increasing a reattempting counter, consider the received cause an abnormal case, and store that the second congestion timer was started when the UE was configured for high priority.

In one embodiment, upon receiving a NAS message including a congestion cause value, the UE configured for high priority may initiate the mobility management procedure immediately. For example, the mobility management procedure is initiated after receiving the NAS message with the cause value indicating the congestion.

### Illustrative Implementations

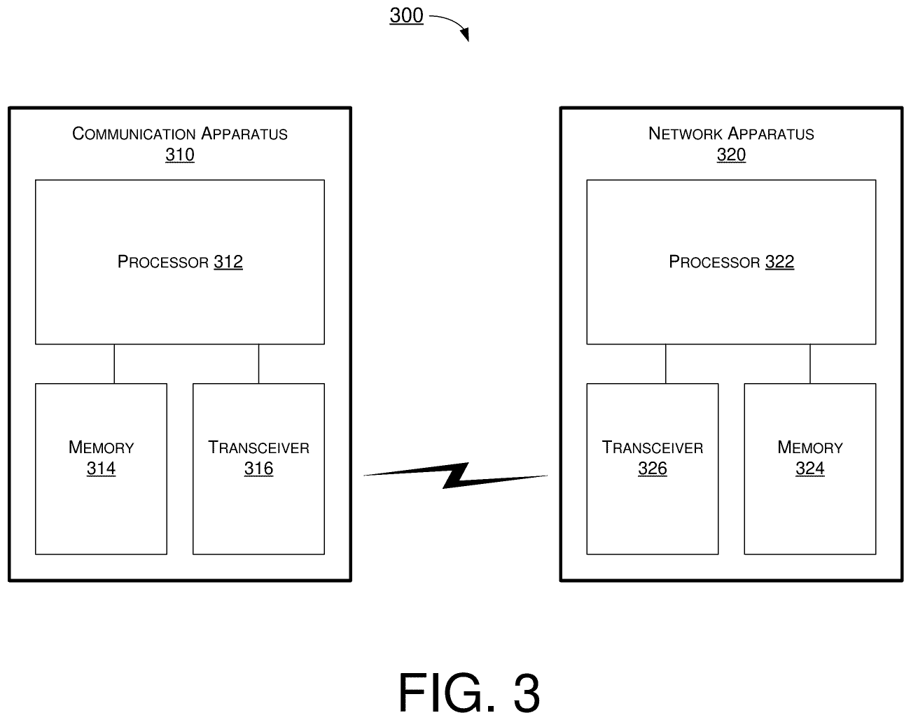

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to congestion rejection handling for high priority UE in mobile communications, including scenarios/schemes described above as well as process 400 described below.

Communication apparatus 310 may be a part of an electronic apparatus, which may be a UE such as a portable or mobile apparatus, a wearable apparatus, a wireless communication apparatus, or a computing apparatus. For instance, communication apparatus 310 may be implemented in a smartphone, a smartwatch, a personal digital assistant, a digital camera, or a computing equipment such as a tablet computer, a laptop computer, or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router, or a gateway. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including congestion rejection handling in a high priority device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

### Illustrative Processes

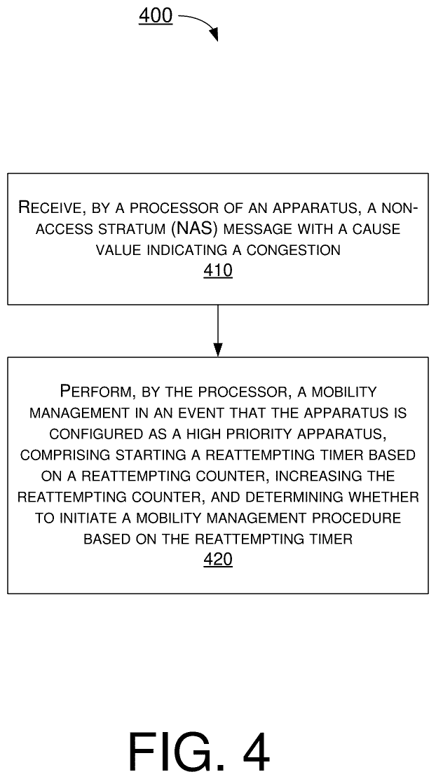

FIG. 4 illustrates an example process 400 in accordance with an implementation of the present disclosure. Process 400 may be an example implementation of above scenarios/schemes, whether partially or completely, with respect to congestion rejection handling for high priority UE of the present disclosure. Process 400 may represent an aspect of implementation of features of communication apparatus 310. Process 400 may include one or more operations, actions, or functions as illustrated by one or more of blocks 410 to 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At block 410, process 400 may involve processor 312 of communication apparatus 310 receiving, via transceiver 316, a NAS message with a cause value indicating a congestion. For example, the NAS message may be sent from a network node (e.g., network apparatus 320). Process 400 may proceed from block 410 to block 420.

At block 420, process 400 may involve processor 312 of communication apparatus 310 performing a mobility management in an event that communication apparatus 310 is configured as a high priority apparatus. The performing of the mobility management may include starting a reattempting timer based on a reattempting counter, increasing the reattempting counter, and determining whether to initiate a mobility management procedure based on the reattempting timer.

In some implementations, the reattempting timer is started in an event that a value of the reattempting counter is less than a predefined value.

In some implementations, a first congestion timer is started after receiving the NAS message for communication apparatus 310 configured as the high priority apparatus. Process 400 may further involve processor 312 initiating the mobility management procedure in an event that at least one of the first congestion timer and the reattempting timer expires.

In some implementations, the mobility management procedure is not initiated while the first congestion timer is running.

In some implementations, process 400 may also involve processor 312 starting a new timer in an event that a value of the reattempting counter reaches a predefined value. Process 400 may further involve processor 312 initiating the mobility management procedure in an event that the new timer expires.

In some implementations, the new timer has a longer waiting period than that of the reattempting timer.

In some implementations, the cause value comprises a 5GMM cause value #22 or EMM cause value #22.

In some implementations, communication apparatus 310 is configured as the high priority apparatus in an event that it is associated with a predefined access class or a predefined access identity.

In some implementations, communication apparatus 310 is configured as the high priority apparatus in an event that it is configured to use AC 11-15 in a selected PLMN.

In some implementations, communication apparatus 310 is configured as the high priority apparatus in an event that it is configured with at least one selected-PLMN-applicable AC in a predefined range on USIM.

In some implementations, the reattempting timer may be a T3402 timer, a T3411 timer, a T3502 timer, or a T3511 timer.

In some implementations, in an event that no congestion timer is running when receiving the NAS message, process 400 may also involve processor 312 starting a first congestion timer. Process 400 may further involve processor 312 determining that the first congestion timer is started for communication apparatus 310 configured as the high priority apparatus.

In some implementations, the first congestion timer is a T3346 timer.

In some implementations, in an event that a first congestion timer is running when receiving the NAS message, process 400 may also involve processor 312 stopping the first congestion timer. Further, process 400 may involve processor 312 starting a second congestion timer.

In some implementations, the mobility management procedure is not initiated while the second congestion timer is running.

In some implementations, at least one of the first congestion timer and the second congestion timer is a T3346 timer.

In some implementations, a timer value is included in the NAS message and the timer value indicates neither zero nor deactivated.

In some implementations, the cause value indicating the congestion is considered as an abnormal case in an event that communication apparatus 310 is configured as the high priority apparatus.

In some implementations, process 400 may also involve processor 312 initiating the mobility management procedure immediately (e.g., after receiving the NAS message with the cause value indicating the congestion).

In some implementations, the NAS message may include a mobility management message, an ATTACH REJECT message, a TRACKING AREA UPDATE REJECT message, or a REGISTRATION REJECT message.

In some implementations, the mobility management procedure may include an attach procedure, a tracking area update procedure, or a registration procedure.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a non-access stratum (NAS) message with a cause value indicating a congestion; and
performing, by the processor, a mobility management in an event that the apparatus is configured as a high priority apparatus, comprising:
starting a reattempting timer based on a reattempting counter;
increasing the reattempting counter; and
determining whether to initiate a mobility management procedure based on the reattempting timer.

2. The method of claim 1, wherein the reattempting timer is started in an event that a value of the reattempting counter is less than a predefined value.

3. The method of claim 1, wherein a first congestion timer is started after receiving the NAS message for the apparatus configured as the high priority apparatus, and wherein the determining of whether to initiate the mobility management procedure further comprises:
initiating the mobility management procedure in an event that at least one of the first congestion timer and the reattempting timer expires.

4. The method of claim 3, wherein the mobility management procedure is not initiated while the first congestion timer is running.

5. The method of claim 1, wherein the performing of the mobility management further comprises:
starting a new timer in an event that a value of the reattempting counter reaches a predefined value; and
initiating the mobility management procedure in an event that the new timer expires.

6. The method of claim 5, wherein the new timer has a longer waiting period than that of the reattempting timer.

7. The method of claim 1, wherein:
the cause value comprises a 5G mobility management (5GMM) cause value #22 or evolved packet system (EPS) mobility management (EMM) cause value #22;
the apparatus is configured as the high priority apparatus in an event that the apparatus is associated with a predefined access class or a predefined access identity;
the apparatus is configured as the high priority apparatus in an event that the apparatus is configured to use access class (AC) 11-15 in selected public land mobile network (PLMN);
the apparatus is configured as the high priority apparatus in an event that the apparatus is configured with at least one selected-PLMN-applicable AC in a predefined range on universal subscriber identity module (USIM); or
the reattempting timer comprises a T3402 timer, a T3411 timer, a T3502 timer, or a T3511 timer.

8. The method of claim 1, wherein in an event that no congestion timer is running when receiving the NAS message, the performing of the mobility management further comprises:
starting a first congestion timer; and
determining that the first congestion timer is started for the apparatus configured as the high priority apparatus.

9. The method of claim 8, wherein the first congestion timer comprises a T3346 timer.

10. The method of claim 1, wherein in an event that a first congestion timer is running when receiving the NAS message, the performing of the mobility management further comprises:
stopping, by the processor, the first congestion timer; and
starting, by the processor, a second congestion timer.

11. The method of claim 10, wherein the mobility management procedure is not initiated while the second congestion timer is running.

12. The method of claim 11, wherein at least one of the first congestion timer and the second congestion timer comprises a T3346 timer.

13. The method of claim 1, wherein a timer value is included in the NAS message and the timer value indicates neither zero nor deactivated.

14. The method of claim 1, wherein the cause value indicating the congestion is considered as an abnormal case in an event that the apparatus is configured as the high priority apparatus.

15. The method of claim 1, wherein the performing of the mobility management further comprises:
initiating the mobility management procedure after receiving the NAS message with the cause value indicating the congestion.

16. The method of claim 1, wherein:
the NAS message comprises a mobility management message, an ATTACH REJECT message, a TRACKING AREA UPDATE REJECT message, or a REGISTRATION REJECT message; or
the mobility management procedure comprises an attach procedure, a tracking area update procedure, or a registration procedure.

17. An apparatus, comprising:
a transceiver which, during operation, communicates wirelessly; and
a processor communicatively coupled to the transceiver such that, during operation, the processor performs operations comprising:
receiving, via the transceiver, a non-access stratum (NAS) message with a cause value indicating a congestion; and
performing a mobility management in an event that the apparatus is configured as a high priority apparatus, comprising:
starting a reattempting timer based on a reattempting counter;
increasing the reattempting counter; and
determining whether to initiate a mobility management procedure based on the reattempting timer.

18. The apparatus of claim 17, wherein a first congestion timer is started after receiving the NAS message for the apparatus configured as the high priority apparatus, and during operation, the processor further performs operations comprising:
starting the reattempting timer in an event that a value of the reattempting counter is less than a predefined value; and
initiating the mobility management procedure in an event that at least one of the first congestion timer and the reattempting timer expires.

19. The apparatus of claim 17, wherein during operation, the processor further performs operations comprising:
starting a new timer in an event that a value of the reattempting counter reaches a predefined value; and
initiating the mobility management procedure in an event that the new timer expires.

20. The apparatus of claim 17, wherein:
the cause value comprises a 5G mobility management (5GMM) cause value #22 or evolved packet system (EPS) mobility management (EMM) cause value #22;
the apparatus is configured as the high priority apparatus in an event that the apparatus is associated with a predefined access class or a predefined access identity;
the apparatus is configured as the high priority apparatus in an event that the apparatus is configured to use access class (AC) 11-15 in selected public land mobile network (PLMN);
the apparatus is configured as the high priority apparatus in an event that the apparatus is configured with at least one selected-PLMN-applicable AC in a predefined range on universal subscriber identity module (USIM);
the reattempting timer comprises a T3402 timer, a T3411 timer, a T3502 timer, or a T3511 timer;
the NAS message comprises a mobility management message, an ATTACH REJECT message, a TRACKING AREA UPDATE REJECT message, or a REGISTRATION REJECT message; or
the mobility management procedure comprises an attach procedure, a tracking area update procedure, or a registration procedure.
